(19) United States
(12) Patent Application Publication
(10) Pub. No.: US 2019/0120469 A1
(43) Pub. Date: Apr. 25, 2019

(54) TILTABLE WORK LIGHT

(71) Applicant: COAST CUTLERY CO., Portland, OR (US)

(72) Inventors: Gregory David Windom, Portland, OR (US); Stephen E. Hubert, Portland, OR (US); Douglas R. Hutchens, Lake Oswego, OR (US); David D. Lewin, Portland, OR (US); Hai Rong Shi, Yangjiang (CN)

(21) Appl. No.: 15/792,625

(22) Filed: Oct. 24, 2017

(51) Int. Cl. F21V 21/30; F21V 21/096; F21V 21/14

(52) U.S. Cl. CPC F21V 21/30; F21Y 2115/10; F21V 21/145; F21V 21/0965

(57) ABSTRACT

A work light including a body with an upper portion having a slot defined therein, the slot encompassing a pivoting portion, the pivoting portion carrying a lens and a light source, the pivoting portion pivoting the lens and the light source in an arc of at least about 180 degrees.

### FIELD OF THE INVENTION

The invention relates generally to a work light with a tiltable head

### BACKGROUND

Work lights have been used for many years to illuminate large areas, normally for work purposes. They are typically designed to sit on a flat, horizontal surface but they sometimes can be clamped or otherwise affixed to other surfaces. Since the introduction of LED technology, additional design options have become available. However, many such lights do not combine a compact design with a high degree of adjustability. And, of course, many such lights are simply not very attractive to the potential customer/user.

### BRIEF DESCRIPTION OF THE DRAWINGS

FIG. 1 is a perspective view of an embodiment from an underside angle;

FIG. 2 is a perspective view of the depicted embodiment from an upper angle;

FIG. 2A is a side elevation view of the depicted embodiment showing it being mounted to a pipe;

FIG. 3A is a side elevation view from the left side of the depicted embodiment with the light in a horizontal disposition but showing, in phantom, the light being pivoted from side to side;

FIG. 3B is a side elevation view from the right side of the depicted embodiment with the light in a horizontal disposition;

FIG. 4A is a side elevation view from the right side of the depicted embodiment with the light in a vertical disposition;

FIG. 4B is a rear elevation view of the depicted embodiment with the light in a vertical disposition;

FIG. 5 is an elevation view from the front of the depicted embodiment showing the light in a horizontal, forward disposition, and a recharging cord;

FIG. 6 is an elevation view from the rear of the depicted embodiment showing the light in a horizontal, forward disposition;

FIG. 7 is a view from the bottom of the depicted embodiment;

FIG. 8 is a view from the top of the depicted embodiment showing the light in a horizontal disposition;

FIG. 9 is an exploded perspective view from the underside of the depicted embodiment with the base removed to reveal a battery compartment and battery pack;

FIG. 10 is a side elevation sectional view taken along line 10-10 of FIG. 4B with the light in a vertical disposition; and

FIG. 11 is a side elevation sectional view taken along line 11-11 of FIG. 4A with the light in a vertical disposition.

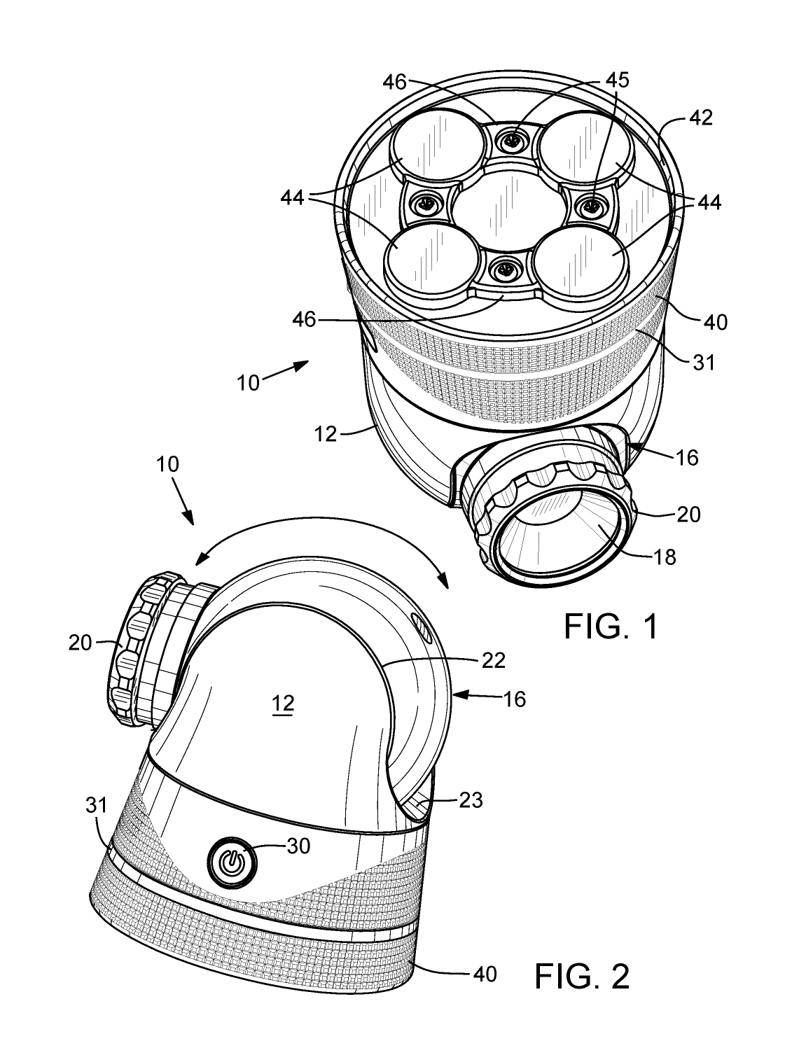

### DETAILED DESCRIPTION OF THE PREFERRED EMBODIMENT

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

A work light is provided that includes a body with an upper portion having a slot defined therein, the slot encompassing a pivoting portion, the pivoting portion carrying a lens and a light source, the pivoting portion pivoting the lens and the light source in an arc of at least about 180 degrees.

The work light may also include an abutment that the lens approaches at the end of about 180 degrees of pivoting. It may also include a detent system providing stops as the pivoting portion is pivoted through the arc. The detent system may be in the form of a pair of plates with spaced holes therein to removably receive a pair of spring-loaded balls, or it may be in the form of a shaft having flattened portions therein, which cooperate with a tensioning member as the shaft is turned.

Referring to the figures, the work light is identified generally with the numeral 10. It is comprised of a substantially cylindrical but somewhat conical body 12 that is domed at an upper portion 14. A rounded, pivoting portion 16 is included in the upper portion 14 of body 12, along with a lens 18 with a surrounding focusing bezel 20. Focusing bezel 20 is typically designed to permit the work light to be adjusted between a spot or flood light and a wider display. The shape of pivoting portion 16 may conform to the domed upper portion 14 to present a smooth, clean look, with the pivoting portion and the domed upper portion combining to form a substantially hemispherical top of the light. Pivoting portion 16 may fit snugly into an enlarged slot 22 in upper portion 14 so that it may maintain its pivoting or rotational position unless manually displaced from that position. However, instead or in addition, a detent system, described below, may be utilized.

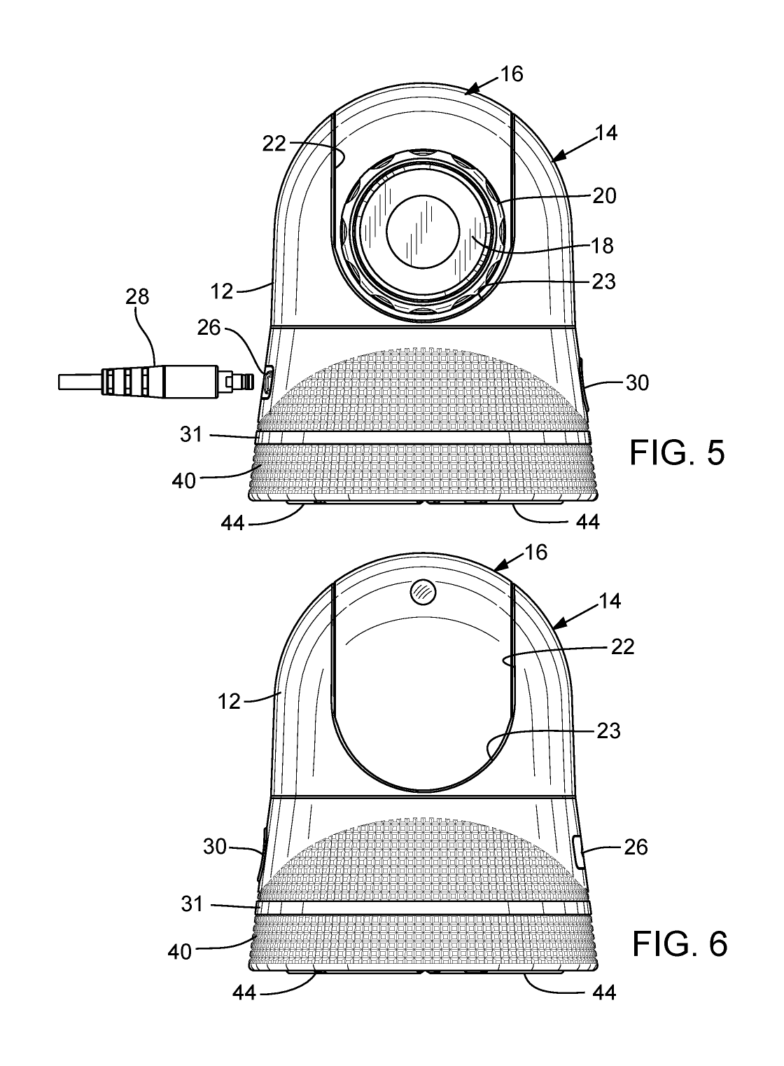

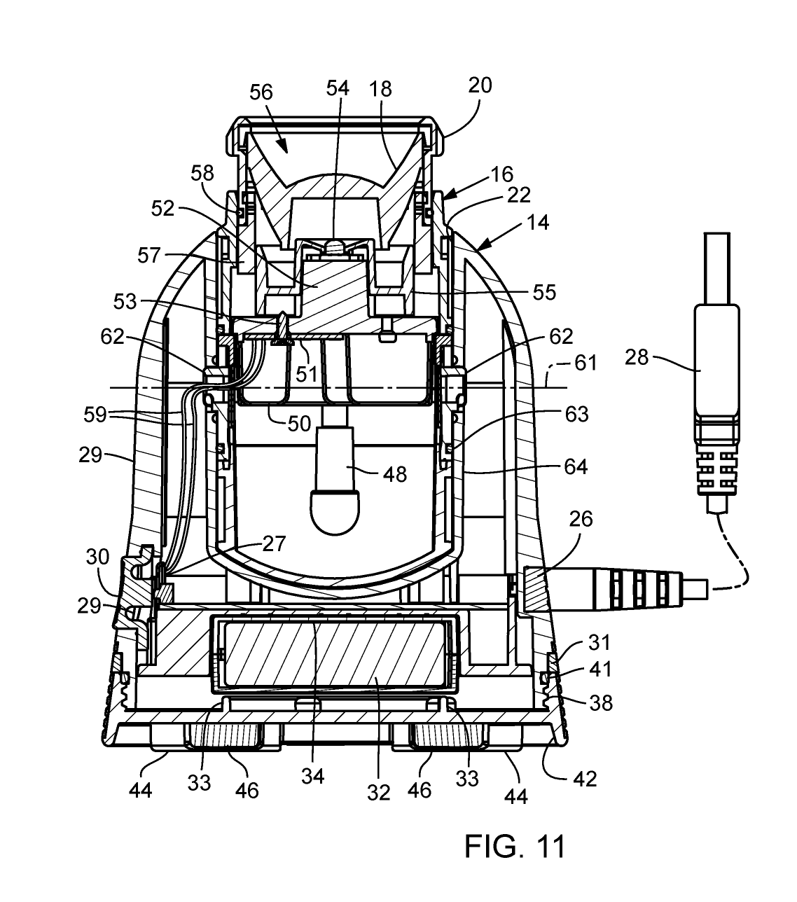

The lens 18 and its focusing bezel 20 are designed to pivot from side-to-side in enlarged slot 22 along axis 61 (shown in FIG. 11) in an arc of approximately 180 degrees defined between a pair of annular abutments 23 that the lens and the focusing bezel approach at either end of their pivoting range. The body 12 may be broken at a mid-point so that a top portion of the body rotates with respect to a bottom portion. However, this is an optional feature as the entire work light might simply be moved to accommodate the needs of the user. Also provided is a power plug or UBS connection 26 designed to recharge a rechargeable battery, although alternatively, the work light might simply plug in with a cord, or the work light may be supplied with conventional batteries. A recharging cord is depicted at 28 (see FIGS. 5 and 11) and a power switch is shown at 30. A power switch void 29 (see FIG. 11) is included in the depicted embodiment to enable the switch to be fully depressed. A first printed circuit board 27 is disposed under power switch 30 adjacent power switch void 29.

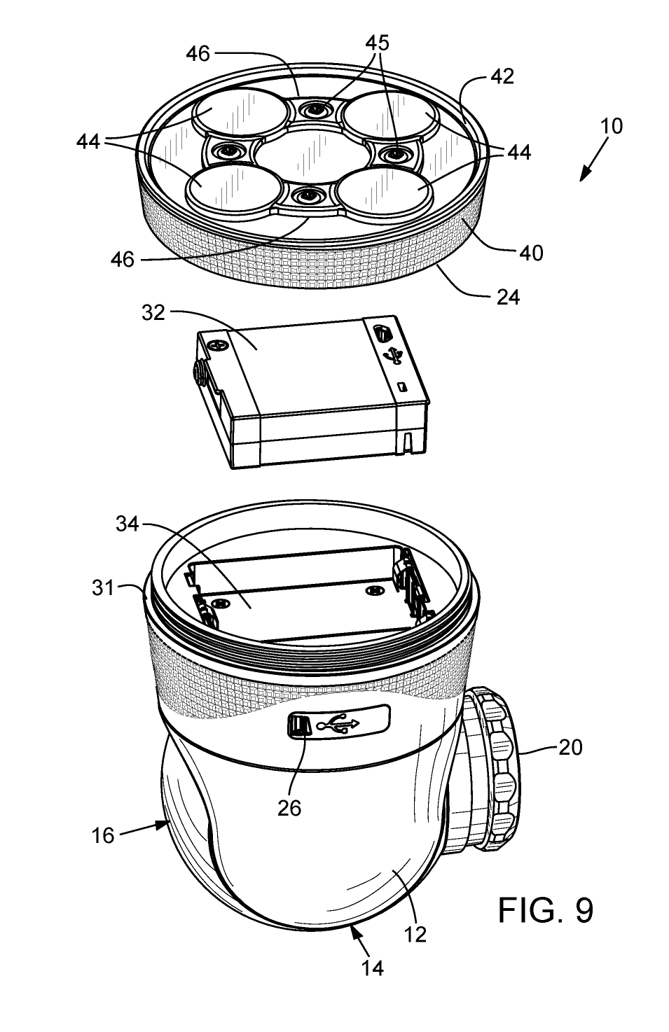

A decorative ring is identified at 31, although it may be at this area, work light 10 could be designed to swivel. The preferred battery arrangement is shown in FIGS. 9-11. It includes a lithium battery 32, which plugs into a battery receptacle 34. This receptacle may be accessed by removing a base 40, which may be engaged with the rest of body 12 by threads 38. An O-ring 41 is typically included to ensure that the work light is water-resistant. A raised feature 33 may be provided to properly position battery 32. Alternatively, work light 10 may be powered by conventional batteries, or may simply plug in using AC power.

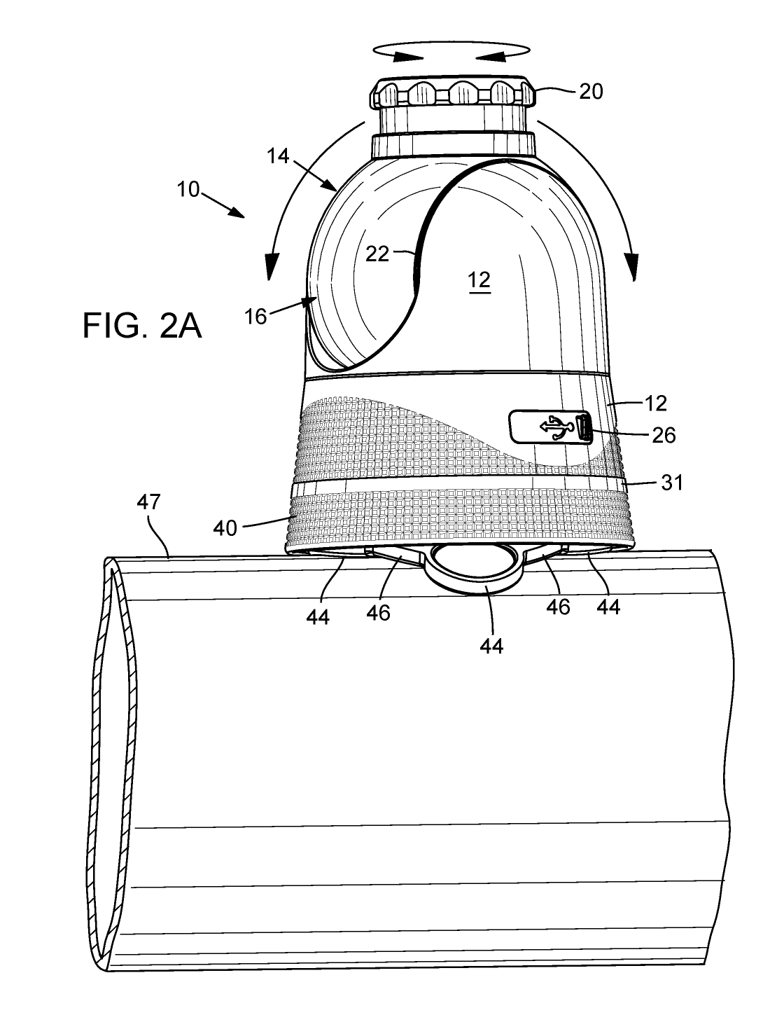

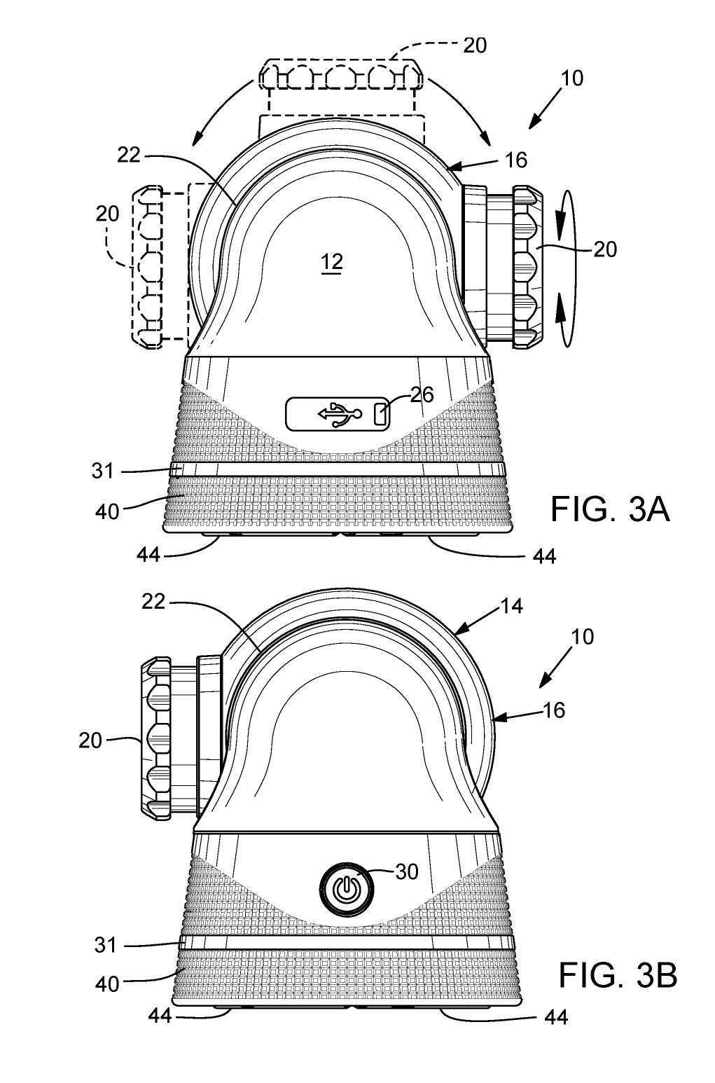

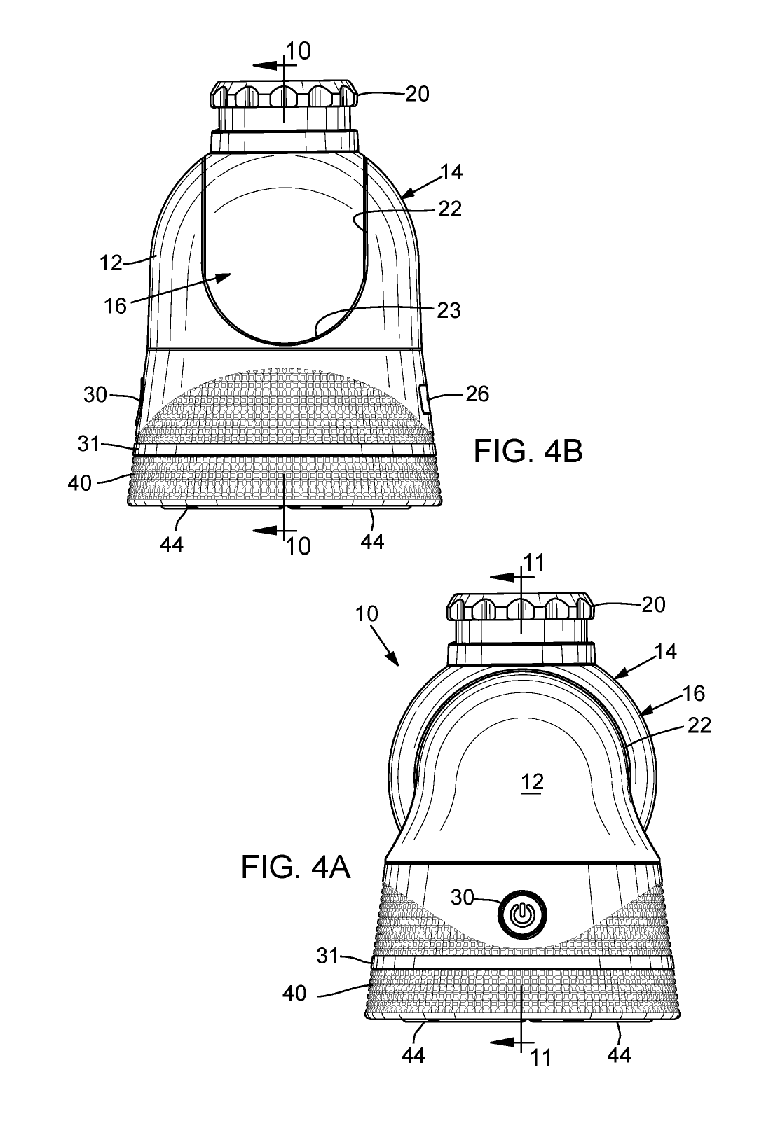

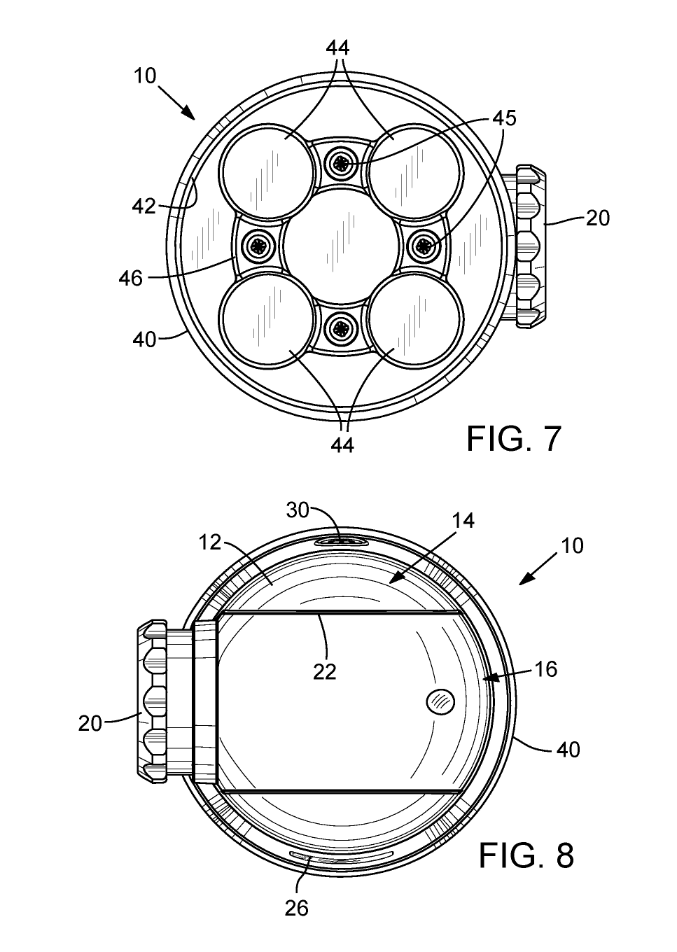

Base 40 is best shown in FIGS. 7 and 9-11. It is substantially flat but may include a recessed portion 42 for receiving a plurality of magnets 44 to facilitate the mounting of work light 10 to a variety of surfaces. In the depicted embodiment, four such magnets 44 are shown, with flexible branches 46 extending between them and fastened to the base such as by screws 45. In fact, branches 46 may be so flexible as to facilitate the mounting of the work light to a wide variety of surfaces, even those that are rounded, such as a pipe 47 shown in FIG. 2A. Magnets 44 are typically high performance magnets such as those formed partially of nickel so the work light may be mounted securely to a wide variety of surfaces and be subjected to vibration or other movement. The use of magnets facilitates the easy relocation of the work light, and often renders unnecessary the rotatability feature previously described, as the light may be simply removed from the surface to which it is mounted, be manually rotated, and then re-mounted to the surface.

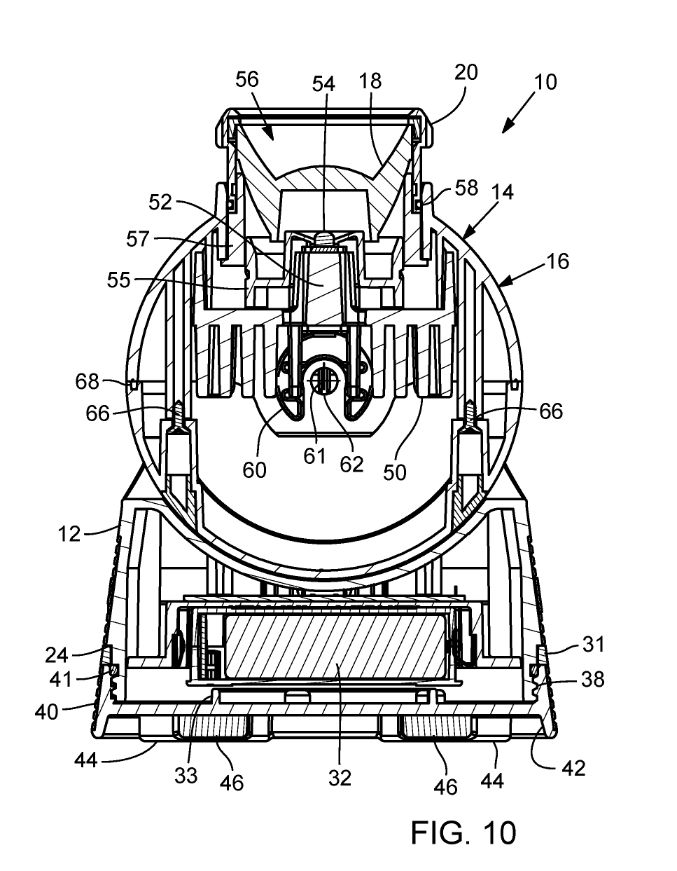

FIGS. 10 and 11 show various internal components. A bolt 48 is shown in FIG. 10, which holds many of the internal components together, such as a heat sink 50 and an LED stand-off 52, which holds an LED 54 in place. A second printed circuit board 51 is held in place by a screw 53. A pair of wires, schematically shown at 59, extend between second printed circuit board 51 and first printed circuit board 27 to provide power to the LED from battery 32 via power switch 30. Wires 59 are slackened to enable pivoting portion 16, LED 54 and lens 18 to pivot along axis 61 by as much as 180 degrees or even more, as described above. A stationary member 55, designed to properly position LED stand-off 52, is engaged with a rotatable member 57 by coarse threads (not shown), with the rotatable member rotating with the turning of focusing bezel 20. An O-ring 58 is depicted to provide water-resistance capability to the turning of focusing bezel 20. An optic is shown at 56. The depicted optic 56 is shown to be combination convex/concave but the optic may take a variety of shapes.

As mentioned previously, the pivotable components may simple be designed to tightly fit into slot 22 so the light will stay in place until its angular position is manually moved. However, as shown in FIG. 10, the depicted work light 10 includes a piece, typically metal, 60 may be provided to apply tension onto flat stops (not shown) formed in a pivot shaft 62. This provides a detent action as pivoting portion 16 is pivoted between vertical and horizontal positions, to facilitate stops therebetween. Alternatively, detents may be in the form of spherical, spring biased balls 63 that partially fit into one or more holes (not shown) in a pair of circular plates 64 on either side of the work light. The holes may or may not extend all of the way through the plates. There may be any number of desired positions and corresponding holes but detents every 10-20 degrees may be appropriate. Both detent systems have been shown in FIG. 11 but normally only one such system would be utilized.

FIG. 10 also shows that two screws 66 may be used to hold two halves of body 12 together. An alignment ring 68 may be provided at the joint between the two halves to facilitate the alignment of the halves prior to sealing them together, such as by sonic welding.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

1-20. (canceled)

21. A work light designed to be placed on a flat, stationary surface, comprising:
a base forming a lower portion of the work light;
a pair of supports extending upwardly from the base, the supports defining a slot therebetween;
a pivoting portion disposed between the supports within the slot, the pivoting portion and the supports together forming a substantially hemispherical upper portion of the work light;
a light source mounted on the pivoting portion so that when the pivoting portion is pivoted from side to side, the light source is pointed in different directions.

22. The work light of claim 21 wherein the base has a lower periphery and further comprising a flexible member mounted to the base adjacent the lower periphery, and a plurality of magnets mounted to the base.

23. The work light of claim 21 wherein the base is flat and generally circular.

24. The work light of claim 23 wherein the base extends upwardly with a generally frustoconical configuration.

25. The work light of claim 21 wherein the upper portion is rotatable with respect to the base.

26. The work light of claim 10 wherein the light source includes a bezel and a lens, the lens having a cover that does not extend above the bezel.

27. The work light of claim 26 wherein the cover of the lens is generally planar.

28. A work light forming a generally hemispherical shape comprising:
a pair of upwardly extending supports defining a slot therebetween;
a rounded pivoting portion disposed between the supports within the slot, the pivoting portion and the supports together forming the substantially hemispherical shape; and
a light source mounted on the pivoting portion so that when the pivoting portion is pivoted from side to side, the light source is pointed in different directions.

29. The work light of claim 28, further comprising a base having a circular configuration at a lower edge thereof, the base being mounted to the supports.

30. The work light of claim 28, further comprising a base to which the supports are mounted, the supports being rotatable with respect to the base.

31. The work light of claim 28, wherein the supports extend from at least one support lower end, and further comprising a frustoconical base extending upwardly to the at least one support lower end.

32. The work light of claim 31, wherein the supports extend from a single lower end and the frustoconical base extends upwardly to and is connected to the lower end of the support.

33. A work light comprising:
a substantially cylindrical base defining a first axis;
a light mount that is mounted to the base to rotate on a second axis that is substantially perpendicular to the first axis; and
a light disposed in the light mount to rotate with the rotation of the light mount to shine the light in a variety of directions.

34. The work light of claim 33 wherein the base is somewhat frustoconical.

35. The work light of claim 33 wherein the light mount is also rotatable on the first axis.

36. The work light of claim 35 wherein the light is rotatable with respect to the base.

37. The work light of claim 33 wherein the light is also rotatable on a third axis perpendicular to the first and second axes.

38. The work light of claim 33 where in the light is also rotatable on the first axis and on a third axis perpendicular to the first and second axes.
